(19) United States
(12) Patent Application Publication
(10) Pub. No.: US 2009/0132354 A1
(43) Pub. Date: May 21, 2009

(54) METHODS, SYSTEMS, AND COMPUTER PROGRAM PRODUCTS FOR AUTOMATICALLY MANAGING PROCUREMENT OF ADVERTISED PRODUCTS, SERVICES, AND EVENTS

(75) Inventor: Dale Malik, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 11/941,130

(22) Filed: Nov. 16, 2007

(51) Int. Cl. G06Q 30/00

(52) U.S. Cl. 705/14

(57) ABSTRACT

Automatically managing procurement of advertised products, services, and events is performed by transmitting content that includes an advertisement and an information matrix. The information matrix includes at least one of an advertisement identifier indicative of the product, service, or event; a date identifier; or a set of rule parameters specifying offer conditions. A signal is received that is indicative of a user expressing a conditional interest in procuring the advertised product or service, or procuring one or more tickets for the event. The conditional interest is predicated upon specified procurement conditions being met. An updated set of rule parameters is received specifying updated offer conditions. The procurement conditions are compared against the offer conditions. Based upon the comparison, an updated offer is transmitted for the product, service, or event.

### FIELD OF INVENTION

Exemplary embodiments relate generally to processing electronic content and, more specifically, to methods, computer program products, and systems for automatically managing procurement of advertised products, services, and events.

### BACKGROUND OF THE INVENTION

From time to time, an individual may encounter an advertisement while viewing electronic content. The advertisement may include several informational details about a product, a service, or an upcoming event. In the case of an event, the advertisement may include the name of the event, the venue hosting the event, the date and time of the event, a telephone number or email address for a promoter of the event, a Uniform Resource Locator (URL) for a website that contains more information about the event, or any of various combinations thereof.

In many situations, an individual is interested in procuring the advertised product or service, or interested in procuring tickets for the advertised event. However, the burden is on the individual to remember all details associated with the advertisement. In order to accurately remember these details, the individual may take action such as writing the details on a scrap of paper, whereupon the scrap may become lost or misplaced.

If the advertisement is part of content that has been electronically stored for playback at a later date, the terms of the offer set forth in the advertisement may no longer be applicable. For example, as the date of an event approaches, tickets for the event may sell out. A product may be offered at a special sale price for three days only. Alternatively, if a product has not been selling well, the price of the product may be further reduced from that recited in the advertisement. Unfortunately, existing techniques for procuring advertised goods, services, and tickets for events utilize a simplistic model whereby a person is provided with a single option at a single moment in time. One must either accept the present offer exactly as it stands, or start over again at the very beginning. In view of these shortcomings, what is needed is an improved technique for automatically managing the procurement of goods, services, and tickets for events.

### SUMMARY OF THE INVENTION

Exemplary embodiments relate to methods for automatically managing procurement of advertised products, services, and events. The methods include transmitting content that includes an advertisement and an information matrix, wherein the advertisement is associated with a product, service, or event, and the information matrix includes at least one of: an advertisement identifier indicative of the product, service, or event; a date identifier indicating an advertisement date; or a set of rule parameters specifying one or more offer conditions pertaining to the product, service, or event. A signal is received that is indicative of a user expressing a conditional interest in procuring the advertised product or service, or procuring one or more tickets for the event. The conditional interest is predicated upon one or more specified procurement conditions being met, the signal including one or more parameters indicative of the one or more procurement conditions. At least a portion of the information matrix is transmitted. An updated set of rule parameters is received specifying one or more updated offer conditions pertaining to the product, service, or event. The one or more procurement conditions are compared to the one or more offer conditions. Based upon the comparison, an updated offer is transmitted for the product, service, or event. An alert is transmitted that includes at least one rule parameter from the updated set of rule parameters.

Another set of exemplary embodiments include computer program products for automatically managing procurement of advertised products, services, and events. The computer program products include a storage medium readable by a processing circuit and storing instructions for execution by the processing circuit for facilitating a method. The method includes transmitting content that includes an advertisement and an information matrix, wherein the advertisement is associated with a product, service, or event, and the information matrix includes at least one of: an advertisement identifier indicative of the product, service, or event; a date identifier indicating an advertisement date; or a set of rule parameters specifying one or more offer conditions pertaining to the product, service, or event. A signal is received that is indicative of a user expressing a conditional interest in procuring the advertised product or service, or procuring one or more tickets for the event. The conditional interest is predicated upon one or more specified procurement conditions being met, the signal including one or more parameters indicative of the one or more procurement conditions. At least a portion of the information matrix is transmitted. An updated set of rule parameters is received specifying one or more updated offer conditions pertaining to the product, service, or event. The one or more procurement conditions are compared to the one or more offer conditions. Based upon the comparison, an updated offer is transmitted for the product, service, or event. An alert is transmitted that includes at least one rule parameter from the updated set of rule parameters.

Another set of exemplary embodiments include a system for automatically managing procurement of advertised products, services, and events. The system includes a content delivery mechanism, operatively coupled to a network, for transmitting content that includes an advertisement and an information matrix, wherein the advertisement is associated with a product, service, or event, and the information matrix includes at least one of: an advertisement identifier indicative of the product, service, or event; a date identifier indicating an advertisement date; or a set of rule parameters specifying one or more offer conditions pertaining to the product, service, or event. A procurement manager server, operatively coupled to the network, receives a signal that is indicative of a user expressing a conditional interest in procuring the advertised product or service, or procuring one or more tickets for the event. The conditional interest is predicated upon one or more specified procurement conditions being met, the signal including one or more parameters indicative of the one or more procurement conditions. The procurement manager server is capable of transmitting at least a portion of the information matrix to an information updating system for the advertisement. The procurement manager server is capable of receiving an updated set of rule parameters from the information updating system for the advertisement specifying one or more updated offer conditions pertaining to the product, service, or event. The procurement manager server compares one or more procurement conditions to the one or more offer conditions. Based upon the comparison, the procurement manager server transmits an updated offer for the product, service, or event. The procurement manager server transmits an alert that includes at least one rule parameter from the updated set of rule parameters.

Other methods, computer program products, and systems according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF THE DRAWINGS

Referring now to the drawings wherein like elements are numbered alike in the several FIGURES:

FIG. 1 is a simplified block diagram of an exemplary system for automatically managing procurement of advertised products, services, and events.

FIG. 2 is a flowchart of an exemplary procedure for automatically managing procurement of advertised products, services, and events.

The detailed description explains the exemplary embodiments, together with advantages and features, by way of example with reference to the drawings.

### DETAILED DESCRIPTION OF THE INVENTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

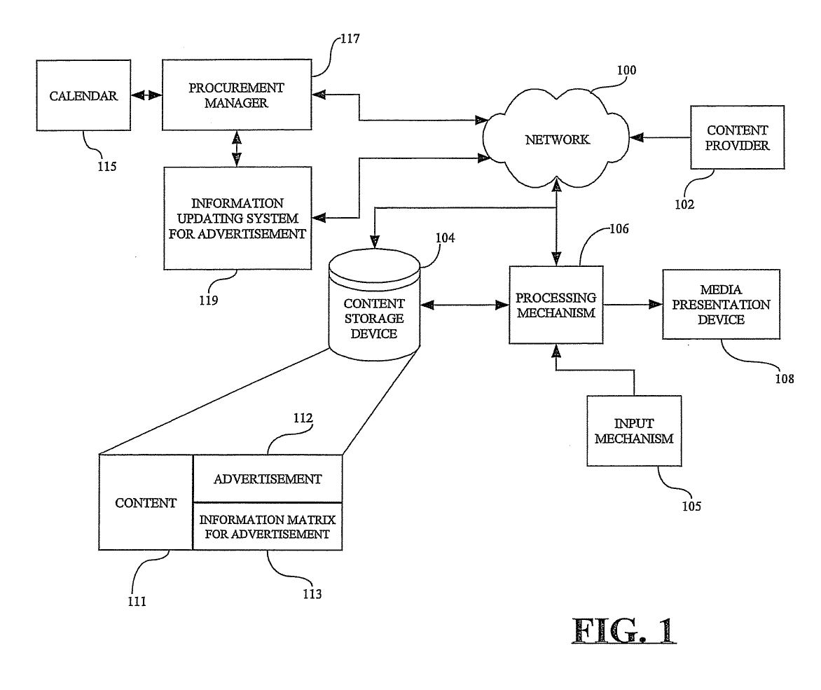

FIG. 1 is a simplified block diagram of an exemplary system for automatically managing procurement of advertised products, services, and events. A content provider 102 delivers content 111 over a network 100 to a content storage device 104, such as a digital video recorder (DVR) or digital audio recorder. The content 111 is subsequently retrieved by a processing mechanism 106, such as a set-top box or computing device, for display on a media presentation device 108, such as an electronic display screen, a loudspeaker, or both. According to exemplary embodiments, the content 111 includes an advertisement 112 associated with an information matrix for advertisement 113. The advertisement 112 may represent an advertisement for a product, a service, or an event. The information matrix for advertisement 113 may include several informational details about the product, service, or event.

In practice, a number of different advertisements may be provided in content 111, or a particular advertiser may provide a number of different advertisements pertaining to different events, products or services. Accordingly, the information matrix for advertisement 113 may include a numeric, alphanumeric, or alphabetic advertisement identifier code that identifies a specific advertisement 112 included in the content 111. The information matrix for advertisement 113 may also include a set of rule parameters specifying one or more offer conditions pertaining to the product, service, or event. For example, these rule parameters may illustratively include a price for the product, service, or event, and a list or range of dates for which the price is effective.

In the case of an event, the information matrix for advertisement 113 may include the name of the event. For example, the name of the event may be a play entitled “Beauty and the Beast™”, or round trip airline tickets on United Airlines from New York to Chicago. The information matrix for advertisement 113 may also include a time availability parameter specifying one or more dates and times for which tickets are available, or a range of dates and times for which tickets are available, or both. Moreover, the information matrix for advertisement 113 may, but need not, include a name for the venue hosting the event, such as the historic Civic Opera House in Chicago. Optionally, the information matrix for advertisement 113 may include an opening date parameter specifying the opening date of the event, such as March 2^{nd}. Optionally, the information matrix for advertisment 113 may include a location parameter setting forth an address for the venue, such as 200 South Wacker Drive. Optionally, the information matrix for advertisement 113 may include an electronic destination for a source of the advertisement in the form of a Uniform Resource Locator (URL) for a website associated with the event. For example, digitized information about the event may be accessed and downloaded from this website. The information matrix for advertisement 113 may, but need not, contain information in addition to that described above.

In the case of a product or service, the information matrix for advertisement 113 may include the name of the product or service. For example, the name of a service may be a generic category such as Housekeeping Services or a specific service provider such as “Bertha's Housekeeping Service™”. The information matrix for advertisement 113 may also include a time availability parameter specifying one or more dates and times for which the product or service is available at a given price, or a range of dates and times for which the price is available, or both. Moreover, the information matrix for advertisement 113 may, but need not, include a location or locations for which the product or service is available at a given price. Optionally, the information matrix for advertisement 113 may include an electronic destination for a source of the advertisement in the form of a Uniform Resource Locator (URL) for a website associated with the product or service and accessible over the network 100. For example, digitized information about the event may be accessed and downloaded from this website. The information matrix for advertisement 113 may, but need not, contain information in addition to that described above.

When the processing mechanism 106 retrieves the content 111 from the content storage device 104 and the content 111 is played back on the media presentation device 108, a viewer or listener may be interested in procuring a product, service, or event ticket corresponding to a product, service, or event included in the advertisement 112. Accordingly, an input mechanism 105, such as a keyboard or computer mouse, accepts a user input indicative of a user expressing a conditional interest in procuring the advertised product or service, or procuring one or more tickets for the event. The processing mechanism 106, operatively coupled to the network 100, receives the user input, illustratively in the form of a signal that is indicative of a user expressing a conditional interest in procuring the advertised product or service, or procuring one or more tickets for the event. The conditional interest is predicated upon one or more specified procurement conditions being met, the signal including one or more parameters indicative of the one or more procurement conditions.

According to exemplary embodiments, the processing mechanism 106 retrieves at least a portion of the information matrix for advertisement 113 that is associated with the advertisement 112 and transmits at least a portion of the information matrix for advertisement 113 over the network 100. The processing mechanism 106 may also transmit the one or more parameters indicative of the one or more procurement conditions over the network 100. The one or more parameters indicative of the one or more procurement conditions and the at least a portion of the information matrix are received by a procurement manager 117, illustratively implemented by a server, a group of servers, or any of various types of processing mechanisms.

According to exemplary embodiments, the procurement manager 117 receives an updated set of rule parameters specifying one or more updated offer conditions pertaining to the product, service, or event from an information updating system for advertisement 119. The information updating system for advertisement 119 may be implemented by a server, group of servers, or any of various types of processing mechanisms. Illustratively, the information updating system for advertisement 119 may, but need not, be a system operated on behalf of an advertiser. The information updating system for advertisement 119 is operatively coupled to the network 100, to the procurement manager 117, or both. In accordance with exemplary embodiments, the procurement manager 117 is operatively coupled to a calendar 115, such as a time management application, for comparing a current date and time with one or more dates and times set forth in one or more procurement conditions, or for comparing the current date and time with one or more dates and times set forth in one or more offer conditions, or both. For example, the calendar 115 may be used to prevent the procurement manager 117 from sending out updated offers that have already expired.

The procurement manager 117 compares one or more procurement conditions to the one or more offer conditions. Based upon the comparison, the procurement manager 117 may transmit an updated offer for the product, service, or event over the network 100 to the processing mechanism 106, illustratively for viewing or listening on the media presentation device 108. Alternatively or additionally, the updated offer may be transmitted in email format to the processing mechanism 106, wherein the processing mechanism 106 is a computing device such as a laptop computer that is capable of receiving and opening email messages. Alternatively or additionally, the updated offer may be transmitted in the form of an advertisement, instant message, pop-up message, or screen caption in conjunction with an Internet Protocol television (IPTV) program. The procurement manager 117 transmits an alert over the network 100 that includes at least one rule parameter from the updated set of rule parameters. The alert is received by the processing mechanism 106. As indicated above, the alert may, but need not, be provided in the form of an email message. Alternatively or additionally, the updated offer may be transmitted in the form of an advertisement, instant message, pop-up message, or screen caption in conjunction with an Internet Protocol television (IPTV) program.

A non-exhaustive list of examples for the network 100 includes wired or optical networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), or any combination thereof. The network 100 may include any combination of additional communication devices (not shown) such as gateways, routers, switches, and the like. Alternatively or additionally, the network 100 may be implemented using a wireless network. A non-exhaustive list of examples for a wireless network includes any network capable of implementing communication using Direct Sequence—Code Division Multiple Access (DS-CDMA), Global System for Mobile Communications (GSM), North American Digital Cellular (NADC), Time Division Multiple Access (TDMA), Extended-TDMA (E-TDMA), W-CDMA, GPRS, GSM, Enhanced Data for GSM Evolution (EDGE), 3G and 4 G communication, wireless local area networks such as 802.11, Bluetooth™, Zigbee™, ultra wideband (UVB), or various combinations thereof.

The processing mechanism 106 is capable of initiating digital communications over network 100. The processing mechanism 106 may, but need not, be implemented using a set-top box (STB), cellular telephone, wireless telephone, personal digital assistant, laptop computer, personal computer, or microprocessor-based device. The same physical device used to implement the processing mechanism 106 may, but need not, be used to implement any of the input mechanism 105, or the media presentation device 108, or both. The processing mechanism 106 may, but need not, encompass additional communication circuitry such as a radio frequency transceiver of a wireless device, a modem, an Ethernet card, a wireless local area network (WLAN) card, or the like.

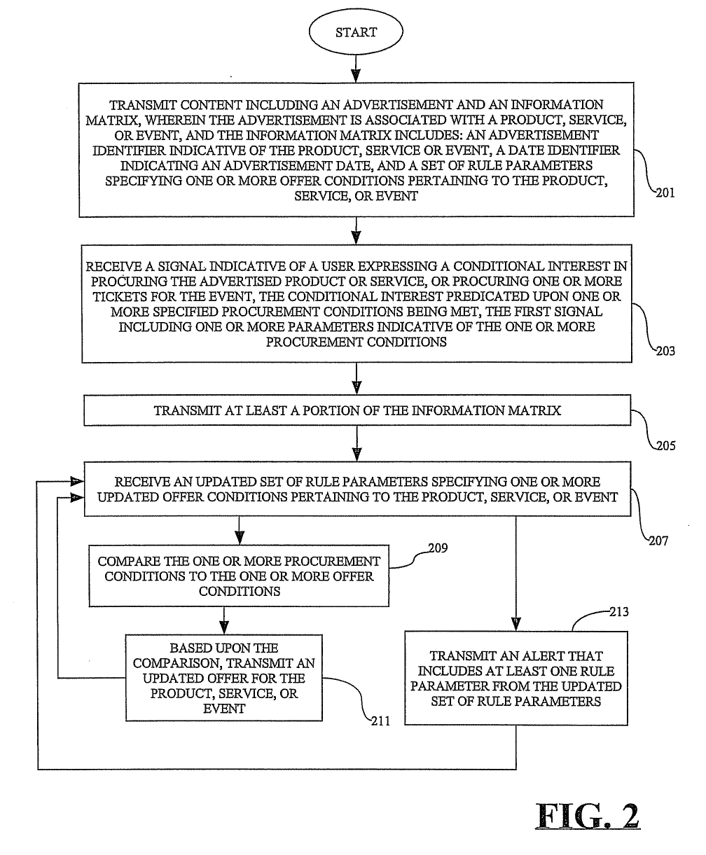

FIG. 2 is a flowchart of an exemplary procedure for automatically managing procurement of advertised products, services, and events. The procedure commences at block 201 where the content 111 (FIG. 1) is transmitted that includes the advertisement 112 and the information matrix for advertisement 113. The content 111, the advertisement 112, and the information matrix for advertisement 113 are sent by the content distributor 102. Alternatively or additionally, the content 111, the advertisement 112, and the information matrix for advertisement 113 are sent by the procurement manager 117, or the information updating system for advertisement 119, or both. Alternatively or additionally, the advertisement 112 and the information matrix for advertisement 113 are sent by the procurement manager 117 over the network 100 to the content distributor 102, and the content distributor 102 combines the advertisement 112 and the information matrix for advertisement 113 with the content 111.

As noted above, the advertisement 112 may be associated with a product, service, or event. The information matrix for advertisement 113 may include: an advertisement identifier indicative of the product, service, or event, a date identifier indicating an advertisement date, and a set of rule parameters specifying one or more offer conditions pertaining to the product, service, or event.

Next, at block 203 (FIG. 2), a signal is received that is indicative of a user expressing a conditional interest in procuring the advertised product or service, or procuring one or more tickets for the event. This signal may be initiated at the input mechanism 105 (FIG. 1), sent by the processing mechanism 106 over the network 100 and then received by the procurement manager 117. The conditional interest is predicated upon one or more specified procurement conditions being met, the signal including one or more parameters indicative of the one or more procurement conditions. These parameters may be specified, for example, by entering information using the input mechanism 105. At block 205 (FIG. 2), at least a portion of the information matrix for advertisement 113 (FIG. 1) is transmitted. For example, after the information matrix 113 is retrieved from the content storage device 104 by the processing mechanism 106, the processing mechanism 106 is programmed to send all or a portion of the information matrix 113 to the procurement manager 117 over the network 100.

An updated set of rule parameters is received specifying one or more updated offer conditions pertaining to the product, service, or event (FIG. 2, block 207). Illustratively, the procurement manager 117 (FIG. 1) issues a query to the information updating system for advertisement 119 that includes information obtained from the information matrix 113 or the procurement conditions or both. In response to this query, the information system for advertisement 119 prepares a set of one or more updated offer conditions and sends the updated offer conditions to the procurement manager 117 where the updated offer conditions are then received by the procurement manager 117.

At block 209 (FIG. 2), the one or more procurement conditions are compared to the one or more offer conditions to generate a comparison result or a set of comparison results. This comparison may be performed by the procurement manager 117 (FIG. 1), by the information updating system for advertisement 119, or both. If the information updating system for advertisement 119 performs the comparison, then the information updating system for advertisement 119 may transmit the result or set of results to the procurement manager 117 where the result or set of results of the comparison are received. For example, one or more respective procurement conditions may be compared against one or more corresponding offer conditions to identify any incompatible conditions, or to identify any compatible conditions, or both. Illustratively, a first procurement condition may specify a date of February 7^{th}. A first offer condition may specify a range of dates from February 1^{st} to February 28^{th}. Accordingly, in this example, a compatible condition has been identified. However, if the first procurement condition specified a date of March 7^{th}, whereas the first offer condition specified a range of dates from February 1^{st} to February 28^{th}, this would be indicative of an incompatible condition. A similar analysis would apply to a procurement condition and an offer condition, each specifying a time of day. Likewise, a second procurement condition may specify a price of under $400, whereas a second offer condition may specify a price of $399, thus indicating a compatible condition. A third procurement condition may specify a departure location of Chicago-O'Hare Airport whereas a third offer condition may specify a departure location of Chicago-Midway Airport, thus indicating an incompatible condition.

Based upon the result or set of results for the comparison, an updated offer is transmitted for the product, service, or event (FIG. 2, block 211). This step may be performed by the procurement manager 117 (FIG. 1), by the information updating system for advertisement 119, or both. If the information updating system for advertisement 119 transmits the updated offer, then the information updating system for advertisement 119 may transmit the updated offer to the procurement manager 117 where the updated offer is received and then sent over the network 100 to the processing mechanism 106, illustratively for viewing or listening on the media presentation device 108. Alternatively or additionally, the updated offer may be transmitted in email format to the processing mechanism 106, wherein the processing mechanism 106 is a computing device such as a laptop computer that is capable of receiving and opening email messages. Alternatively or additionally, the updated offer may be transmitted in the form of an advertisement, instant message, pop-up message, or screen caption in conjunction with an Internet Protocol television (IPTV) program.

At block 213 (FIG. 2), an alert is transmitted that includes at least one rule parameter from the updated set of rule parameters. As indicated above, this step may be performed by the procurement manager 117 (FIG. 1) transmitting an alert over the network 100 that includes at least one rule parameter from the updated set of rule parameters. The alert is received by the processing mechanism 106. As indicated above, the alert may, but need not, be provided in the form of an email message. Alternatively or additionally, the updated offer may be transmitted in the form of an advertisement, instant message, pop-up message, or screen caption in conjunction with an Internet Protocol television (IPTV) program.

Optionally, receiving an updated set of rule parameters (FIG. 2, block 207), comparing the one or more procurement conditions (block 209), transmitting an updated offer (block 211), and transmitting an alert (block 213) are iteratively repeated until a request is received to cancel a procurement of the advertised product or service, or to cancel a procurement of one or more tickets for the advertised event. Such a cancellation request may be entered, for example, into the input mechanism 105 (FIG. 1), received by the processing mechanism 106, sent over the network 100, and received by the procurement manager 117.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for automatically managing procurement of advertised products, services, and events, the method including:
transmitting content that includes an advertisement and an information matrix, wherein the advertisement is associated with at least one of a product, service, or event, and the information matrix includes at least one of: an advertisement identifier indicative of the product, service, or event; a date identifier indicating an advertisement date; or a set of rule parameters specifying one or more offer conditions pertaining to the product, service, or event;
receiving a signal that is indicative of a user expressing a conditional interest in procuring the advertised product or service, or procuring one or more tickets for the event, wherein the conditional interest is predicated upon one or more specified procurement conditions being met, the signal including one or more parameters indicative of the one or more procurement conditions;
transmitting at least a portion of the information matrix;
receiving an updated set of rule parameters specifying one or more updated offer conditions pertaining to the product, service, or event;
comparing the one or more procurement conditions to the one or more offer conditions to generate a comparison result;
transmitting an updated offer for the product, service, or event based upon the comparison result; and
transmitting an alert that includes at least one rule parameter from the updated set of rule parameters.

2. The method of claim 1 wherein receiving an updated set of rule parameters, comparing the one or more procurement conditions, transmitting an updated offer, and transmitting an alert are iteratively repeated until a request is received to cancel a procurement of the advertised product or service, or to cancel a procurement of one or more tickets for the advertised event.

3. The method of claim 1 wherein the comparison result is generated by comparing one or more respective procurement conditions against one or more corresponding offer conditions to identify at least one of an incompatible condition and a compatible condition.

4. The method of claim 3 wherein the one or more respective procurement conditions and the corresponding offer conditions include at least one of a price, a location, a date, or a time of day.

5. The method of claim 1 wherein the updated offer is transmitted in an email format.

6. The method of claim 1 wherein the updated offer is transmitted as at least one of an advertisement, instant message, pop-up message, or screen caption in conjunction with an Internet Protocol television (IPTV) program.

7. The method of claim 1 wherein the alert is transmitted in an email format.

8. The method of claim 1 wherein the alert is transmitted as at least one of an advertisement, instant message, pop-up message, or screen caption in conjunction with an Internet Protocol television (IPTV) program.

9. A computer program product for automatically managing procurement of advertised products, services, and events, the computer program product including a storage medium readable by a processing circuit and storing instructions for execution by the processing circuit for facilitating a method comprising:
transmitting content that includes an advertisement and an information matrix, wherein the advertisement is associated with a product, service, or event, and the information matrix includes at least one of: an advertisement identifier indicative of the product, service, or event; a date identifier indicating an advertisement date; or a set of rule parameters specifying one or more offer conditions pertaining to the product, service, or event;
receiving a signal that is indicative of a user expressing a conditional interest in procuring the advertised product or service, or procuring one or more tickets for the event, wherein the conditional interest is predicated upon one or more specified procurement conditions being met, the signal including one or more parameters indicative of the one or more procurement conditions;
transmitting at least a portion of the information matrix;
receiving an updated set of rule parameters specifying one or more updated offer conditions pertaining to the product, service, or event;
comparing the one or more procurement conditions to the one or more offer conditions to generate a comparison result or a set of comparison results;
transmitting an updated offer for the product, service, or event based upon the comparison result or set of comparison results; and
transmitting an alert that includes at least one rule parameter from the updated set of rule parameters.

10. The computer program product of claim 9 wherein receiving an updated set of rule parameters, comparing the one or more procurement conditions, transmitting an updated offer, and transmitting an alert are iteratively repeated until a request is received to cancel a procurement of the advertised product or service, or to cancel a procurement of one or more tickets for the advertised event.

11. The computer program product of claim 9 wherein the comparison result, or set of comparison results, are generated by comparing one or more respective procurement conditions against one or more corresponding offer conditions to identify any incompatible conditions, or to identify any compatible conditions, or both.

12. The computer program product of claim 11 wherein the respective procurement conditions and corresponding offer conditions include at least one of a price, a location, a date, or a time of day.

13. The computer program product of claim 9 wherein the updated offer is transmitted in an email format.

14. The computer program product of claim 9 wherein the updated offer is transmitted as an advertisement, instant message, pop-up message, or screen caption in conjunction with an Internet Protocol television (IPTV) program.

15. The computer program product of claim 9 wherein the alert is transmitted in an email format.

16. The computer program product of claim 9 wherein the alert is transmitted as an advertisement, instant message, pop-up message, or screen caption in conjunction with an Internet Protocol television (IPTV) program.

17. A system for automatically managing procurement of advertised products, services, and events, the system including:
a content delivery mechanism, operatively coupled to a network, for transmitting content that includes an advertisement and an information matrix, wherein the advertisement is associated with at least one of a product, service, or event, and the information matrix includes at least one of: an advertisement identifier indicative of the product, service, or event; a date identifier indicating an advertisement date; or a set of rule parameters specifying one or more offer conditions pertaining to the product, service, or event;
a procurement manager server, operatively coupled to the network, for receiving a signal that is indicative of a user expressing a conditional interest in procuring the advertised product or service, or procuring one or more tickets for the event, wherein the conditional interest is predicated upon one or more specified procurement conditions being met, the signal including one or more parameters indicative of the one or more procurement conditions; and
an information updating system, operatively coupled to at least one of the network or the procurement manager server, the procurement manager server further for:
transmitting at least a portion of the information matrix to the information updating system,
receiving an updated set of rule parameters from the information updating system specifying one or more updated offer conditions pertaining to the product, service, or event,
comparing one or more procurement conditions to the one or more offer conditions to generate a comparison result, and
based upon the comparison result, transmitting an updated offer for the product, service, or event and transmitting an alert that includes at least one rule parameter from the updated set of rule parameters.

18. The system of claim 17 wherein the procurement manager iteratively repeats: receiving an updated set of rule parameters, comparing the one or more procurement conditions, transmitting an updated offer, and transmitting an alert until the procurement manager receives a request to cancel a procurement of the advertised product or service, or to cancel a procurement of one or more tickets for the advertised event.

19. The system of claim 17 wherein the procurement manager generates the comparison result by comparing one or more respective procurement conditions against one or more corresponding offer conditions to identify at least one of an incompatible condition and a compatible condition.

20. The system of claim 19 wherein the respective procurement conditions and the corresponding offer conditions include at least one of a price, a location, a date, or a time of day.
